(19) United States
(12) Patent Application Publication
(10) Pub. No.: US 2008/0187117 A1
(43) Pub. Date: Aug. 7, 2008

(54) System and method for identifying a caller during a phone call

(76) Inventor: Delphine M. Maugars, Mountain View, CA (US)

Correspondence Address: Davidson, Davidson & Kappel, LLC, 485 7th Avenue, 14th Floor, New York, NY, 10018, US

(21) Appl. No.: 11/702,434

(22) Filed: Feb. 5, 2007

(51) Int. Cl. H04M 15/00; H04M 1/56

(52) U.S. Cl. 379/121.01; 379/142.04

(57) ABSTRACT

A method of identifying a caller is provided. The method includes designating a masque phone number to be provided to a caller by a callee and associating the masque phone number with one or more phone numbers designated by the callee. Calls to the masque phone number are routed to a telephone device coupled to the designated phone number. The masque phone number, or text information or an image or a video associated with the masque phone number by the callee, are displayed on a caller identification device associated with the telephone device.

### FIELD OF THE INVENTION

The present invention relates to the field of caller identification services in telephone systems

### BACKGROUND

In telecommunication networks, a telephone number identifies a device with phone capacity. In the wire line part of the network, a number identifies a phone and a phone line. In a wireless network, the phone number identifies a phone or a card placed in the phone. To initiate a phone call, the caller must provide the phone number of the destination of the call. While the destination is known by the caller, the “callee” does not know the origin of the call, unless a specific solution is put in place. Typical solutions are commonly referred to as caller identification services, which enable the display of the number of the caller to the callee.

Existing caller identification methods attempt to identify the caller by the phone number of the phone used to place the call. However, these methods fail to identify the caller in a number of situations, such as: (i) when the caller asks the operator not to communicate the caller number to the callee; (ii) when the caller uses a public phone or a corporate phone line; (iii) when the caller is not using his or her own phone; and (iv) when the call passes through operators that do not transmit the caller id from one network to the other (for example, this commonly occurs with international calls).

As a consequence, under existing systems, the caller can easily be anonymous, thereby thwarting the caller identification scheme.

### SUMMARY OF THE INVENTION

In accordance with a first embodiment of the present invention, a method of identifying a caller is provided. The method includes designating a masque phone number to be provided to a caller by a callee and associating the masque phone number with one or more phone numbers designated by the callee. Calls to the masque phone number are routed to a telephone device coupled to the designated phone number. The masque phone number, or text information or an image or a video associated with the masque phone number by the callee, are displayed on a caller identification device associated with the telephone device. In accordance with a further aspect of this embodiment, a plurality of masque phone numbers may be designated, each associated with one or more phone numbers designated by the callee.

In accordance with a second embodiment of the present invention, a method of identifying a caller comprises associating a masque phone number with one or more destination phone numbers designated by the caller and routing a call to one of the destination phone numbers to a telephone device coupled to said one of the destination phone numbers. The method further comprises displaying the masque phone number, or text information or an image or a video associated with the masque phone number by the caller, on a caller identification device associated with the telephone device. In accordance with a further aspect of this embodiment, a plurality of masque phone numbers may be designated, each associated with one or more destination phone numbers designated by the caller.

In accordance with a third embodiment of the present invention, a system and method of identifying a caller is provided. An interface is provided which is coupled to a processing device, and the processing device is coupled to a telephone network which supports the transmission of caller identification information to caller identification devices. At the interface, a request is received for associating a designated phone number with at least one masque telephone number. The request is communicated to the processing device and the processing device receives calls placed to the masque telephone number. The received calls are forwarded to the designated phone number with the masque telephone number and/or other information associated with the masque number provided to the telephone network as the caller identification information.

In accordance with other aspects of the third embodiment, the association between the masque number and the designated user phone number may be stored in a user accessible database. Billing information and other user profile information may also be stored in the user accessible datable. The interface, through which the requests are received, and through which the database can be accessed, may, for example, be an internet interface or a touch-tone telephone interface.

In accordance with another aspect of the third embodiment, the request may include a request to associate a calling-ID with a phone number, and a call originating from the destination phone number may be communicated to the phone number with the calling-ID provided to the telephone network as the caller identification information.

In accordance with yet another aspect of the third embodiment, the request may include a request to associate one or more of text information, an image and a video with the masque number, and the received calls may be forwarded to the designated phone number with the one or more of the masque telephone number, text information, image, and video associated with the masque number provided to the telephone network as the caller identification information.

In accordance with yet another aspect of the third embodiment, the request may include a request by the owner of the masque number to initiate calls using the masque number to any other destination number, while choosing calling-id to display to the callee.

### BRIEF DESCRIPTION OF THE DRAWINGS

FIG. 1 is a flow chart depicting an exemplary method in accordance with an embodiment of the present invention for setting up a plurality of masque numbers, and receiving calls through the mask numbers at a phone device.

FIG. 2 is a block diagram of an exemplary network for implementing caller-id and calling-id services in accordance with an embodiment of the present invention.

FIG. 3 illustrates an exemplary flow process for a call placed in accordance with the present invention.

### DESCRIPTION

In the discussion that follows, the term “caller-id” means, in accordance with the present invention, the number or other information displayed to an end user of the present invention as an identification of the caller, when the end user is acting as a callee.

The term “calling id” means, in accordance with the present invention, the number presented to a person called by the end user of the present invention, when the end user is acting as a caller.

The term “destination number” means, in accordance with the present invention, the telephone number dialed by a caller to reach a callee.

The term “masque number” means, in accordance with the present invention, the destination number mapped to a phone line or phone device by an owner (who may be a caller or callee) of the masque number, and associated with an individual caller or group of callers. The owner of the masque number chooses which final destination number to which a masque number is mapped.

As such, when the end user receives a call (i.e., is acting as a callee), the “caller-id” is the destination number or masque number selected for the caller by the callee. When the end user initiates a call (i.e., is acting as a caller) to a non-user of the system, the calling-id is the masque number presented to the callee as the end user's telephone number.

As explained above, existing caller identification methods attempt to identify the caller by the phone number of the phone used to place the call. However, these methods fail to identify the caller in a number of situations, such as when the caller asks the operator not to communicate the caller number to the callee; when the caller uses a public phone, a corporate phone line, or is otherwise not using his or her own phone; and when the call passes through operators that do not transmit the caller id from one network to the other.

In accordance with various embodiments of the present invention, a system and method is provided which can identify a caller or a group of callers in wire-line or wireless phone calls, and can identify the caller independent of the operator or the type of phone or phone line used by the caller.

Unlike existing identification solutions which identify the caller based on the origination number of the call, the method and system in accordance with an embodiment of the present invention enables the identifies the caller based on the destination of the call (i.e., the phone number called). In this regard, an end user of the embodiment registers as many destination numbers as necessary to identify individual callers, a group of callers, or a category of callers. These destination numbers, which constitute caller-ID information, are then forwarded to one or more phone devices specified by the end user. The end user can use a conventional caller identification service provided by the operator and a conventional caller identification display device, so that information can be displayed when the phone rings. However, as explained below, when the end user's phone device rings, the caller identification display device (which may or may not be integrated with the phone device) displays the destination number of the callee end user (and/or other caller-ID information such as text (e.g., a name), images, or video), and not the origination number of the caller.

This method provides the ability to identify the caller, independently from the phone used. To reach the destination, the caller must use the destination number. This method is independent from the telephone operator used by the caller, from the phone used, from the location (international calls). As such, the caller cannot hide the identification when the callee uses this method.

In accordance with another embodiment of the present invention, the end user can specify the caller identification information (referred to herein as the calling-ID) which is transmitted to a callee when the end user places a call. The end user can associate different calling-IDs with different destination phone numbers. For example, if the end user has associated a particular caller-ID with an individual, the end user may wish the calling-ID forwarded to this individual's phone to match the caller-ID. To do this, the user can associate that individuals phone number(s) with a calling-ID which is the same as the caller-ID for that individual.

In accordance with other embodiments of the present invention, a software tool is provided which enables the user (the callee) to choose and to modify the caller-id and the calling-id of a phone number with immediate effect on the phone call characteristics via a direct user interface, using any conventional network (the internet, telephone text messages, telephone voice menu, etc). The software tool can also provide the user (who may be a mobile or a fixed line subscriber) with access to activation, configuration, deactivation, call record and billing of a destination phone number and associated services with immediate effect via a direct user interface. In the context of the present invention, a direct user interface is an interface that is directly connected to the telephone call control system, enabling immediate effective modification of the phone call parameters, as contrasted with conventional (indirect) systems which require the services of a call center or other third-party intervention to perform such operations on behalf of the end-user.

Preferably, the direct user interface may include:
1. An interface for modification of the caller-id of a phone number from a user terminal or device;
2. An interface for modification of the calling-id associated with a phone number.
3. The configuration of a pin code enabling access to an external line associated to the caller-id. In this regard, a user can call the masque number after entering the pin code at the direct user interface, and the direct user interface will enable the owner to access a telephone line tone and to dial any regular phone number in order to initiate calls originating from a masque number to any other destination numbers;
4. The real-time and immediate application of the configuration for all calls originated from or destined for a specific phone number, including the activation and desactivation of the masque number; and/or
5. The real-time and immediate access to the record and the billing of all calls originated from or destined for a specific masque phone number via the user interface.

As explained in further detail below, in addition to caller-id information, the method, system, and software can also provide the user with a fast and easy way to control, in real-time the number (calling-ID information, such as text and/or a phone number) used when calling other people and presented to the person the user calls from a masque phone number.

As such, the method, system and software according to embodiments of the present invention can enable the fast configuration of phone calls according to the end-user needs, for example when the end-user would like to disguise the phone number calling or called to protect private information.

In accordance with an exemplary embodiment of the present invention, a user with an existing phone line may decide to provide phone numbers that differ from the existing phone line to individuals or groups of individuals. These phone numbers can then be forwarded to the user's existing phone line or to different phones, at the discretion of the user. When a caller uses one of these numbers to contact the user, the user called obtains the destination number (and NOT the caller's number) through a conventional caller-id display device. The caller does not know if there is a call identification or not via this method, since the implementation makes it look like a regular phone call. This allows the user to identify the caller according to the user's choice, even when the caller uses an anonymous phone like a public phone or a private or corporate number setting.

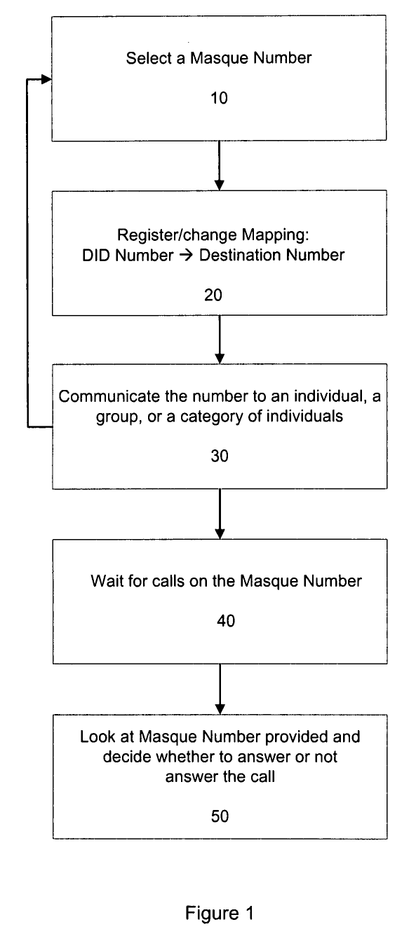

This process is illustrated in FIG. 1. A user of the system in accordance with an embodiment of the present invention, first selects a number to be called from (the masque number) in step 10. This is preferably implemented using a DID (Direct Inward Dialing) number, and is a valid number in any country. DID numbers are well known in the art and details regarding its implementation is therefore omitted. Although DID numbers are preferred, other implementations can alternatively be used. In this regard, any phone number or network identification relevant to a telecom operator in a unified messaging system can alternatively be used. In step 20, the user defines a mapping between the number to be called from (masque number) and a designated user phone number. This mapping indicates which number (the designated user phone number) shall ring when the chosen masque number is called. In step 30, the chosen masque number is provided to an individual, a group or a category of individuals or groups.

The user may optionally insert the chosen number(s) in a source directory, which indicates the individuals, groups, or categories of individuals or groups that are associated with each masque number. An exemplary source directory is illustrated in Table 1:

TABLE 1

| Masque Number | |
|---|---|
| (destination phone number | Contact name |
| dialed by caller) | (caller) |
| Number A | John Sample |
| Number B | Betty Example |
| Number C | Family (partner and children) |
| Number D | Business Customer X |
| Number E | People living in country Y |

The source directory may be used by the system to display the contact name (rather than the masque number) on the user's caller identification device as the caller-ID. Alternatively, the masque number may be displayed on the user's caller identification device, and the source directory may be omitted, or may be implemented as a stand-alone feature not linked to the caller identification device.

Continuing with the example of FIG. 1, in step 40 the user waits for calls on one of the chosen masque numbers, and in step 50 the masque number (or contact name from the source directory) is communicated to the user on his or her caller identification device before answering the call.

As such, the process is transparent from the caller's perspective. The caller dials a phone number for the callee (which is a masque number), the call either established with the destination, routed to a voice mail, or the caller gets a busy tone. The routing of the masque number to the designated user phone number by the system in accordance with the present invention is not revealed to the caller.

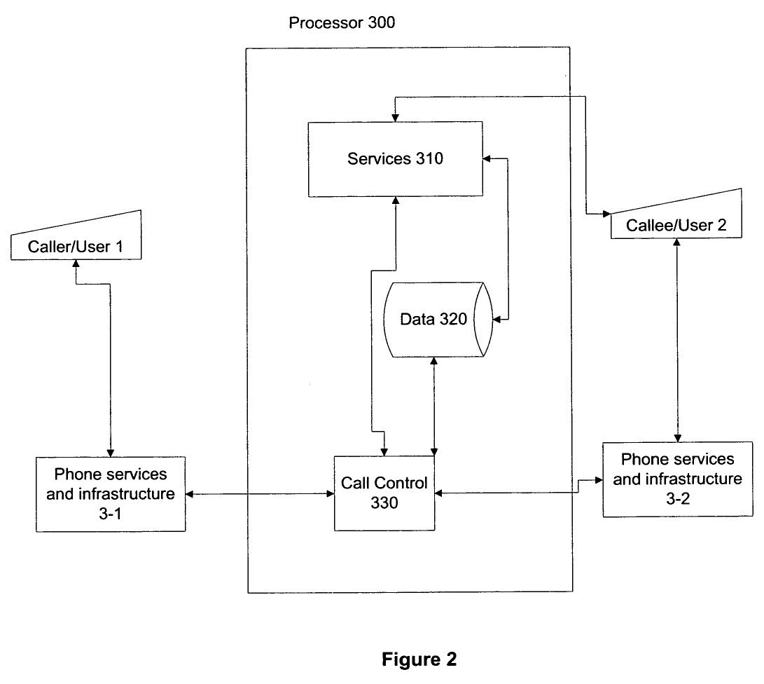

FIG. 2 is a block diagram of an exemplary network for implementing caller-id and calling-id services in accordance with an embodiment of the present invention. It should be appreciated that many alternative implementations are possible, and that the method and system according to the present invention is not limited to any specific implementation. In this regard, alternative implementations include PSTN SCP, Voice Over IP Proxy, PBX, network switch and/or router, and more generally, systems that can route or place a call.

Referring to FIG. 2, a caller 1 and a callee 2 use their existing, conventional telephone services and infrastructure 3.1 and 3.2 respectively (hereinafter “operator(s) 3.1 and operator(s) 3.2). In the system of FIG. 2, operator 3.1 of the caller need not handle, or be capable of handling, caller identification information.

The caller-id and calling-id services can be implemented on a processor 300. It will be appreciated that processor 300 may comprise one or more servers, computers, or other processing equipment. In the exemplary implementation of FIG. 2, the server 300 includes or is coupled to a data repository 320, and executes a services software function 310 and a call control software function 320. It will be appreciated that this system can also be implemented without software, for example, utilizing hard-wired logic circuitry (rather than a soft-ware based processor) coupled to data repository 320. Alternatively, the processor 300 can be implemented as a combination of hard-wired logic circuitry and soft-ware based processors.

Referring to FIG. 2, the call control function 330 of the processor 300 receives any call placed on a destination number at the phone operator 3.1 that corresponds to a masque number associated with the caller-id/calling-id system. The processor 300 receives the call because the destination number has been registered in the telephone network as routed to the server 300 as its destination. This is achieved in the same manner that phone numbers are conventionally associated with destinations.

When the call is received a the processor 300, the call control function 330 accesses the database 320 to identify the designated user phone number associated with the masque number, and then forwards the call to that designated user phone number in a conventional manner, and the call is received by the callee through his or her normal phone operator 3.2.

The services function 310 allows the user to access and configure his or her service and to review the call records and billing details. As such, steps 10 and 20 of FIG. 1 can be implemented by the services function 310. The user can also assign calling-IDs via the services function, and configure the source directory, pin codes, billing options, contact information, pin-code information, passwords, etc.

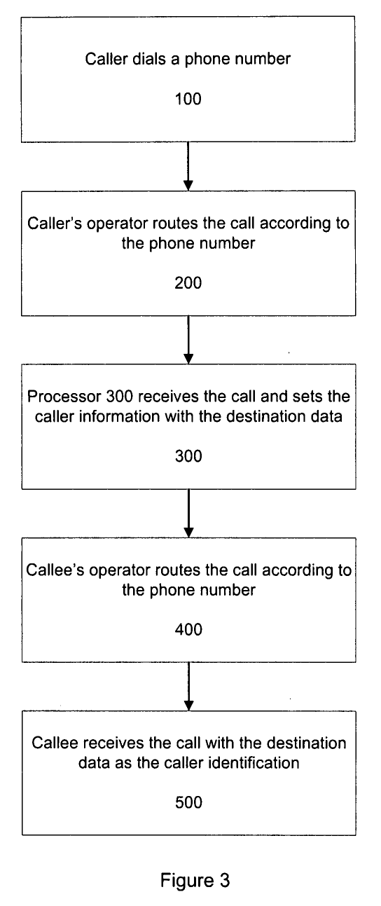

FIG. 3 details the high level steps involved in placing and receiving a phone call in accordance with an embodiment of the present invention. In step 100, the caller 1 dials a number from any phone (wire line, wire less, IP, etc . . . ) anywhere in the world. The only information the caller needs is a regular phone number to reach the destination. The phone number does not have to be from the same country or the same operator as the caller.

In step 200, the operator 3.1 that serves the caller routes the call in the same manner that it routes any other calls. No specific action is required from the operator 3.1. The operator 3.1 can include or not include information regarding the caller when it routes the call. In accordance with the present invention, this information is not needed for the caller-id function of the present invention. It should be noted that several operators 3.1 may be involved to route the call from the caller to the processor 300 although only a single operator 3.1 is shown in FIG. 2. In any event, since the call is processed by the operator 3.1 in the same manner as any call initiated by the caller, the method in accordance with the present invention is transparent to the caller.

In step 300, if the destination number is a masque number associated with the processor 300, the processor 300 receives the call because the destination number has been registered to be routed to processor 300 and not to any other final destination. The processor 300 can receive calls from wire lines, wireless networks and voice-over-ip operators. The destination number is communicated to the processor 300 in the same manner that calls are communicated to any destination.

The processor 300 uses the conventional, known, capacity of the network to propagate caller identification information to forward the caller-ID and does not require that any specific, additional technology be provided by any operator 3.2. The processor 300 sets the caller identification of the call with the destination number information (e.g., the masque/destination number and/or contact name), as opposed to the source number provided originally by the caller. The processor 300 then forwards the call to the designated user phone number as configured by the callee.

In step 400, the operator 3.2 routes the call to the callee. For the method to be fully functional, the operator 3.2 needs to support conventional caller identification features, unless the callee chooses to forward each destination number to different phones. Several operators 3.2 may be involved to route the call for this step.

In step 500, the callee receives the call like any other call except that the caller-id information that is displayed on his or her conventional caller identification device is the masque number and/or associated contact information and/or other text, image or video information designated by the callee. The callee is therefore able to reliably identify the caller, and can decide to forward to answer the call, to forward to a voice mail or to reject the call. The method is independent from the devices used by the callee to answer the call, and is also independent from the device used to get the caller-id information. Further, there is preferably no limit on the number of destination number that a user can configure. So a user can identify as many parties as necessary.

The calling-id functionality will now be described. In order to prevent disclosure of the user's designated phone number when the user calls a one of the individuals or groups to which the user has provided a masque number, the system and method according to a further embodiment of the present invention transmits the corresponding masque number as the calling-ID using the conventional caller identification functionality of the operator 3.1.

Referring to FIG. 2, when the user 2 (now acting as a caller) places a call to the user 1 (now acting as a callee), the user 2 preferably dials the masque number from any telephone device, then dials for example the touch tone “#” once the system answers. An interactive voice response system in processor 300 then asks the user 2 to enter his or her PIN code, previously chosen via the user interface. If the PIN code is valid, the user 2 hears a dial tone, and the user 2 can then dial the number of the user 1 acting as callee. When the user 1 receives the call, the caller-id that is presented is the masque number used by the user 2, or any number the user 2 has chosen to display. Therefore the private phone number of the user 2 is protected, without acting as an undisclosed phone number to the callee like for the traditional systems.

The user 2 can also initiate the call from the web interface, using a form to enter the destination number and to dial out. The user 1 and the user 2 are then placed into a conference, where the processor 300 calls the user 1 on his or her telephone device as described in the previous paragraph, and the processor 300 also calls the user 2 on his or her telephone device, received from his or her masque number. The private phone number of the user 2 is thereby protected.

In any event, referring to FIG. 2, when a user 2 (acting as a caller) places a call to the user 1 (now acting as the callee), the processor 300 routes the call to user 1 via the operator 3.2. The processor 300 maintains a list of calling-id's associated with various destination numbers. This can be implemented for example, as a source directory in database 320 as shown in Table 2:

TABLE 2

| Masque Number | | | |
|---|---|---|---|
| (destination | | | |
| phone number | Contact name | | |
| dialed by caller) | (caller) | Calling-ID | Destination Number |
| Number A | John Sample | Number A | John Samples Tel. No. |
| Number B | Betty Example | Number B | Betty Example's Tel. No. |
| Number C | Family | | |
| Number D | Business | Number D | Business Customer X |
| | Customer X | | Tel. No. |
| | Person X | Number E | |
| | All others | Number A | |

The call control process 330 in the processor 300 identifies the destination number of the call as a listed destination number, and then transmits the associated calling-id to the destination number using the conventional calling identification functionality of the operator 3.1. It should be noted that while in Table 2, the source directory indicates a default calling-id number for “all others”, the system could alternatively simply pass on any caller identification information generated by the operator 3.2 to the operator 3.1, or you replace the caller identification information generated by the operator 3.2 with null information (e.g, all 0's).

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method of identifying a caller, comprising:
designating a masque phone number to be provided to a caller by a callee;
associating one or more masque phone numbers with one or more phone numbers designated by the callee;
routing calls to the masque phone number to a telephone device coupled to the designated phone number; and
displaying the masque phone number, or text information or an image or a video associated with the masque phone number by the callee, on a caller identification device associated with the telephone device.

2. The method of claim 1, further comprising designating a plurality of masque phone numbers, each associated with one or more phone numbers designated by the callee.

3. A method of identifying a caller, comprising:
associating a masque phone number with one or more destination phone numbers designated by the caller;
routing a call to one of the destination phone numbers to a telephone device coupled to said one of the destination phone numbers; and
displaying the masque phone number, or text information or an image or a video associated with the masque phone number by the caller, on a caller identification device associated with the telephone device.

4. The method of claim 1, further comprising designating a plurality of masque phone numbers, each associated with one or more destination phone numbers designated by the caller.

5. A method of identifying a caller, comprising:
providing an interface coupled to a processing device, the processing device coupled to a telephone network which supports the transmission of caller identification information to caller identification devices;
receiving, at the interface, a request for associating a designated phone number with at least one masque telephone number;
communicating said request to the processing device;
receiving, at the processing device, calls placed to the masque telephone number; and
forwarding the received calls to the designated phone number with the masque telephone number and/or other information associated with the masque number provided to the telephone network as the caller identification information.

6. The method of claim 5, wherein the request includes a request to associate a calling-ID with a phone number, and wherein the method further comprises communicating a call originated from the destination phone number to the phone number; with the calling-ID provided to the telephone network as the caller identification information.

7. The method of claim 6, wherein the calling ID is the masque telephone number.

8. The method of claim 5, wherein the at least one masque number includes a plurality of masque numbers.

9. The method of claim 5, wherein the step of receiving a request comprises receiving a request to associate one or more of text information, an image and a video with the masque number, and wherein the step of forwarding the received calls comprises forwarding the received calls to the designated phone number with the one or more of the masque telephone number, text information, image, and video associated with the masque number provided to the telephone network as the caller identification information.

10. The method of claim 5, further comprising storing the association between the masque number and the designated user phone number in a user accessible database.

11. The method of claim 9, further comprising storing the association between the masque number and the designated user phone number and the one or more of the text information, image and video in a user accessible database.

12. The method of claim 10, further comprising storing billing information in the user accessible database.

13. The method of claim 9, wherein the request is received via an internet interface.

14. A system for identifying a caller, comprising:
an interface coupled to a processing device, the processing device coupled to a telephone network which supports the transmission of caller identification information to caller identification devices;
the interface receiving a request for associating a masque telephone number with a designated telephone number and communicating this request to the processing device;
the processing device configured to receive calls placed to the masque telephone number and forward the received calls to the designated phone number with the masque telephone number and/or other information associated with the masque number, provided to the telephone network as the caller identification information.

15. The system of claim 14, wherein the interface is an internet interface.

16. The system of claim 14, wherein the interface is a telephone interface.

17. The system of claim 14, wherein the interface is a direct user interface.

18. The system of claim 17, wherein the direct user interface is operable to selectively associate and disassociate the masque telephone number from the designated telephone number.

19. The system of claim 14, wherein the interface is accessible by a user, and is configured to provide billing information to the user.
